(19) United States
(12) Patent Application Publication
(10) Pub. No.: US 2011/0171904 A1
(43) Pub. Date: Jul. 14, 2011

(54) METHOD AND SYSTEM FOR MONITORING A PERSON WEARING A BADGE AND LIKELY TO BE IN POTENTIALLY HIGH-RISK AREA

(75) Inventors: Yannick Dessertenne, Angers (FR); Frederic Galtier, Paris (FR)

(73) Assignee: NEXESS, Valbonne-Sophia Antipolis (FR)

(21) Appl. No.: 13/002,384

(22) PCT Filed: Jul. 2, 2009
(86) PCT No.: PCT/EP2009/058342

§ 371 Date: Mar. 14, 2011

(30) Foreign Application Priority Data
Jul. 4, 2008 (FR) 08/54545

(51) Int. Cl. H04B 7/24

(52) U.S. Cl. 455/39

(57) ABSTRACT

A method and system is provided for monitoring a person likely to be in a potentially high-risk area. The method is characterized in that it comprises a step of activating a radio frequency communication apparatus, referred to as a beacon; a step of broadcasting a signal carrying piece of information about a risk occurring in the potentially high-risk area and defines the type of risk and a level of seriousness thereof; a step of receiving a signal carrying the piece of risk information by a badge worn by the person; a step of transmitting by the badge, an identifier of the person to the beacon; a step for determining, by the badge, a piece of information disclosing the person at risk; and a step of transmitting the of disclosing information to a remote apparatus responsible for centralized risk management.

### SUMMARY OF THE INVENTION

The problem solved by the present invention is therefore to centralise the data on exposure of a person to a risk present in a potentially high-risk area on a site, for example an industrial site.

To this end the invention concerns a procedure for monitoring a person liable to be in a potentially high-risk area. The process is characterised in that it comprises a stage of activating a radiofrequency communication apparatus referred to as a beacon, a step (2) of broadcasting a signal carrying information about the risk present in said potentially high-risk area which defines the type of risk and its level of severity, a step of receiving a signal carrying the risk information by a badge worn by the person, a step of transmission by the badge of an identifier of the person to the beacon, a step for determining by the badge the information on exposure of the person to the risk, and a step of transmitting the exposure information to a remote apparatus responsible for centralised risk management.

The present invention also concerns a monitoring system implementing said method and a beacon and badge used by said system.

### BRIEF DESCRIPTION OF THE DRAWINGS

The characteristics of the invention mentioned above and others will appear more clearly from reading the description below of an embodiment, said description being produced with relation to the attached drawings where:

FIG. 1 indicates diagrammatically an example of the monitoring system of a person likely to be in a potentially high-risk area;

FIG. 2 shows a diagram of the steps of the monitoring process of a person liable to be in a high-risk area;

FIG. 3 shows diagrammatically the internal means of the beacon according to the invention;

FIG. 4 shows diagrammatically the internal means of a badge according to the invention; and

FIG. 5 shows diagrammatically another example of the system for monitoring a person likely to be in a potentially high-risk area.

### DETAILED DESCRIPTION OF THE PREFERRED EMBODIMENT(S)

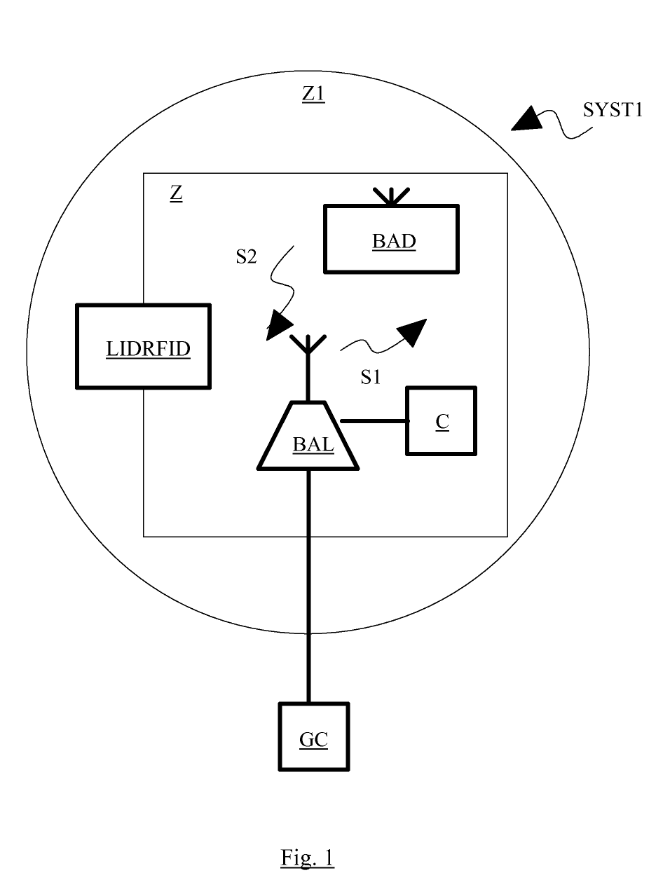

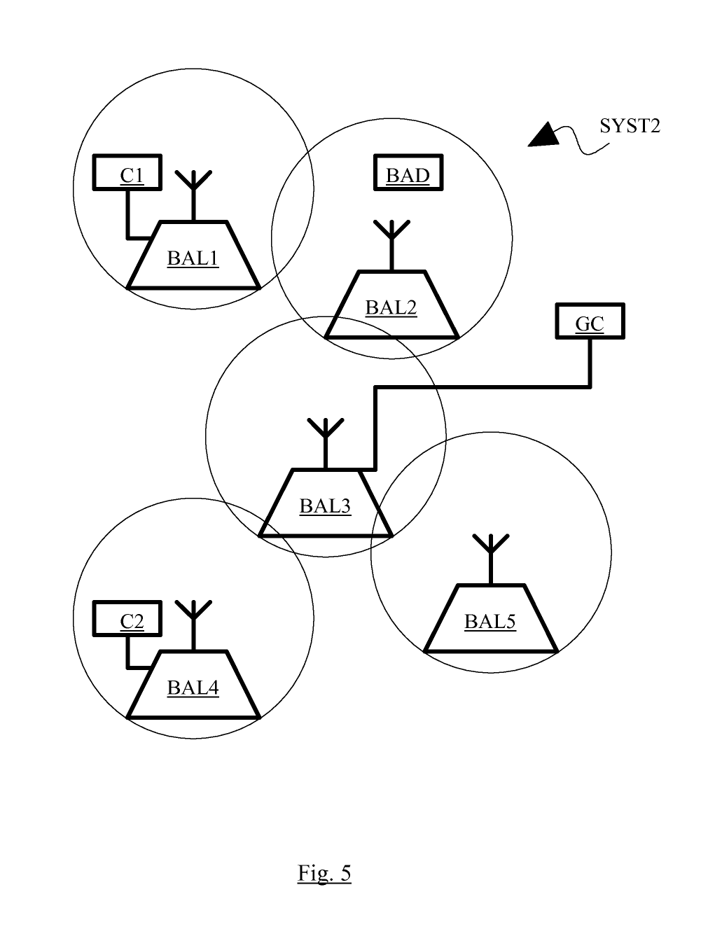

The present invention concerns a method for monitoring of a person wearing a badge and liable to be in a potentially high-risk area, a method which is implemented by a system, examples of which are given in FIGS. 1 and 5.

FIG. 1 shows an example of a system SYST1 for monitoring a person likely to be in a potentially high-risk area Z indicated diagrammatically by a rectangle.

The system SYST1 comprises a radiofrequency communication apparatus known as a beacon BAL, the cover area Z1 of which indicated diagrammatically by a circle centred of the antenna of the beacon BAL is at least equal to the potentially high-risk area Z. The system also comprises an apparatus GC located outside the potentially high-risk area Z which is responsible for centralised management of the monitoring system and which is connected to the beacon BAL by hard-wired or radiofrequency means.

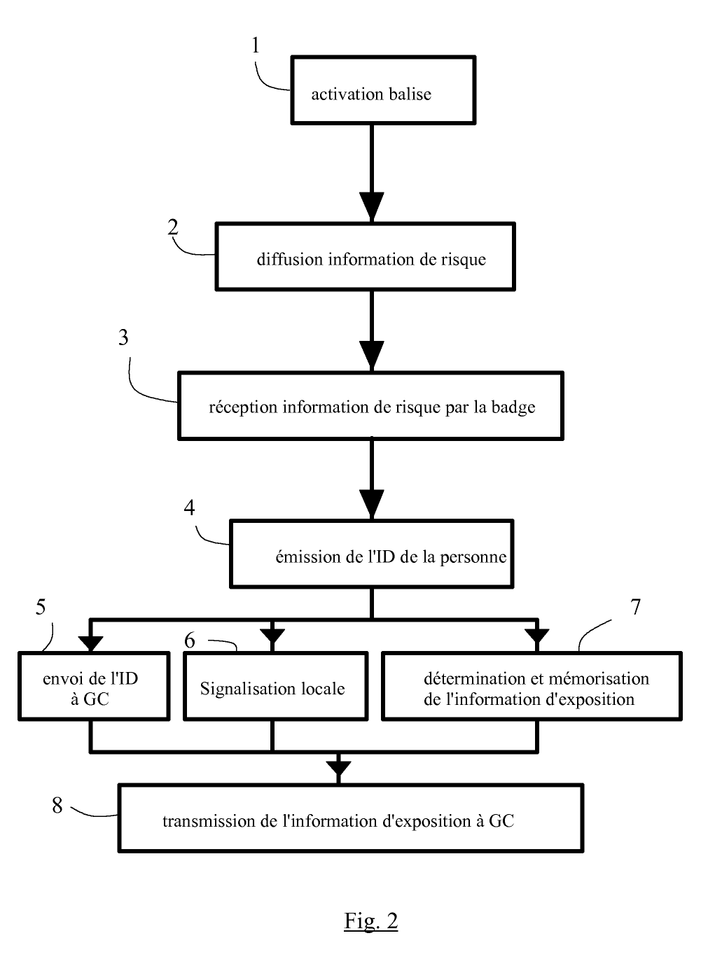

At rest, the beacon BAL does not broadcast any signal. However as soon as it is activated (step 1 of FIG. 2) either directly by a user or by means of a remote trigger, the beacon BAL broadcasts a signal S1 carrying risk information IR (step 2). This risk information IR describes the type of risk occurring in the area Z and the level of severity of the risk. For example the risk is exposure to radiation and the level is given by a integral value of a value scale.

When the beacon BAL is activated directly by the user, the risk information IR carried by the signal Si is obtained from a memory MBAL of the beacon BAL.

According to a variant, the beacon BAL comprises a graphic interface IHMBAL from which the user activates the beacon BAL and where applicable can enter a risk type and a level of severity of this risk.

When the beacon BAL is activated by a remote trigger, the remote trigger is connected to the beacon by either hard-wired or radiofrequency communication means.

According to one embodiment of the system, the remote trigger is another beacon which distributes a signal carrying risk information.

According to an embodiment of the system, the remote trigger is a detector C, the function of which is to detect a risk which can occur in at least a part of the area Z located around this detector. The detector C then transmits to the beacon BAL a signal carrying binary information that a risk has been detected. On reception of this signal, the beacon finds in its memory MBAL the risk information corresponding to the indication received.

As a variant, the detector C transmits the risk information IR directly to the beacon BAL. In this case the risk detector C comprises individual means which define in particular the risk data which it transmits and which is relative to the risk it has detected. It is therefore understood that if more than one type of risk is liable to be detected by the detector C, the risk information transmitted by the detector C may differ in nature according to the risk detected by the detector. It is also noted that the type and/or level of risk which detector C is able to detect are as a variant defined by a remote device such as the beacon BAL then fitted with interface IHMBAL or a device which is preferably connected to the beacon BAL by hard-wired or radiofrequency means, such as for example the apparatus GC.

The system SYST also comprises a badge BAD worn by a person.

When the badge BAD arrives under the cover of the beacon BAL then activated, the badge BAD receives signal S1 and detects that it has just entered a risk zone (step 3).

The badge BAD then emits a radiofrequency signal S2 carrying an identifier ID of the person wearing it (step 4), an identifier which has first been memorised in the memory MBAD of the badge.

According to a variant of the method, on reception of signal S2, the beacon BAL transmits a signal carrying the identifier ID of the person to the apparatus GC informing it that this person has entered the risk area Z (step 5). The apparatus GC can then for example transmit an alarm signal in the area Z or to emergency personnel.

According to a variant of the method, the badge BAD indicates in an audible and/or visual manner to the person wearing it that the latter has entered a high-risk area (step 6). This signalling stops as soon as the badge BAD has detected that it is no longer under the cover of the beacon BAL.

Further to step 4, the badge determines so-called exposure information EXP (step 7). For this the badge determines its distance DIS in relation to the beacon BAL. For example the badge BAD sends a signal Si1 of given power level P1. Following reception of Si1, the beacon BAL responds with a signal Si2 of the same power level P1. On reception of signal Si2, the badge BAD determines at which power level P2 it has received this signal Si2. The badge then determines the distance separating it from the beacon BAL based on the difference in power levels P1 and P2 and the propagation time of the waves carrying these signals Si1 and Si2. The badge BAD determines, while it is under cover of the activated beacon BAL and at regular intervals, the distance DIS separating it from the beacon BAL so that firstly it can update this distance when the person is moving in the cover zone of the beacon and secondly to detect when the badge is no longer in the cover zone of the beacon BAL. The badge memorises the duration D for which it has remained under cover of the activated beacon BAL i.e. the duration for which the person has been exposed to the risk. It also memorises the distance or distances DIS which have separated it from beacon BAL during period D.

Thus whenever the badge BAD is under cover of the beacon BAL during a period D, exposure information EXP is determined and memorised by the badge BAL in a memory MBAD. Each exposure information EXP includes one or more distances of the badge from the beacon and the risk information broadcast by the beacon BAL during this period D.

The badge BAD then transmits the saved exposure information IR to the apparatus GC as soon as it is within the range of this device (step 8). The apparatus GC can then determine the processing of the exposure data to establish in particular statistics on the risks incurred by persons who have been exposed to one or more risks.

According to one embodiment of the system, communication of exposure information IR between the badge BAD and the apparatus GC takes place via a reader LRFID, type RFID long distance, preferably using frequency 868 Mhz. The reader LRFID is a reader which allows data communication with the badge BAD up to a distance of three metres by implementation preferably of protocol type EPC Class 1 GEN 2, EPC Class 1 GEN 1 or ISO 18000-6c.

According to a variant of the system, access to the potentially high-risk area Z is controlled either by a secure identifier reader LIDRFID or by the reader LRFID or by both.

When the access control is performed by the reader LIDRFID, the person presents his badge to the reader to check his identity, whereas when access control is performed by the reader LRFID, the person does not need to present the badge to the reader as the data stored in the memory MBAD can be accessed remotely by the reader. Communication between the badge BAD and the reader LIDRFID is implemented preferably by technology to standard ISO 14443. It is noted that on communication between the badge BAD and the reader LRFID, the reader can recover exposure data IR stored in the memory MBAD. Thus the apparatus GC can obtain this data when it is connected to the reader.

Furthermore readers LIDRFID and/or LRFID, when in communication with the badge BAD, supply the badge BAD with energy.

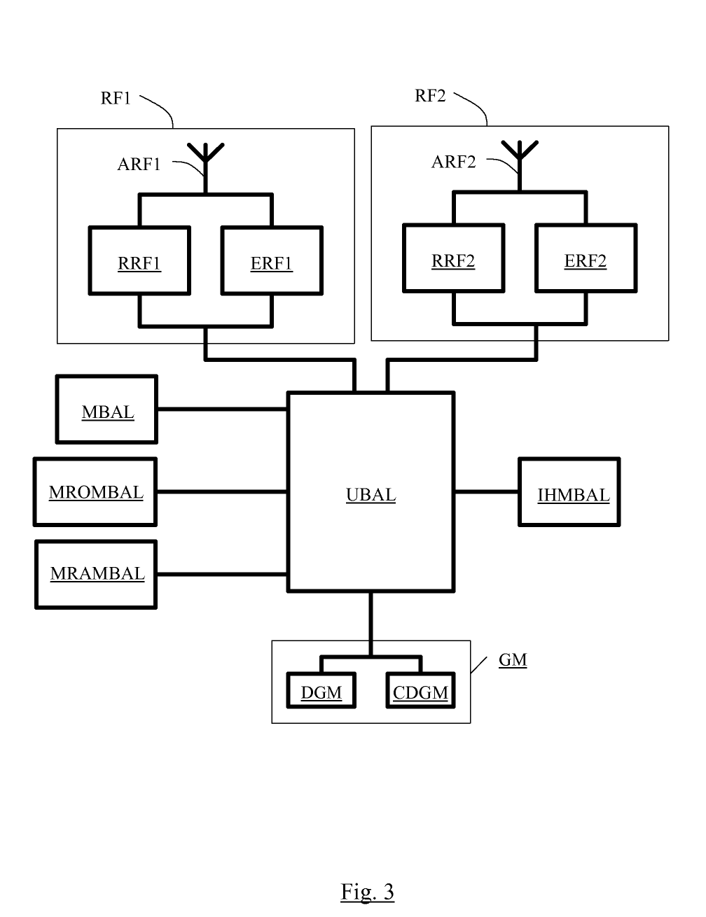

FIG. 3 indicates diagrammatically the means internal to the beacon BAL.

The beacon BAL comprises a processing unit UBAL intended to implement a set of instructions for a program PROG. For this the processing unit UBAL is associated with a ROM-type memory MROMBAL which memorises the set of instructions implementing the steps of the method in FIG. 2 and a RAM-type memory MRAMBAL.

The beacon BAL also comprises a first radiofrequency communication device RF1 provided to communicate with a badge BAD and a second radiofrequency communication device RF2 provided to communicate with apparatus GC and with another beacon. The devices RF1 and RF2 both communicate with the processing unit UBAL.

The device RF1 which preferably uses frequency 868 Mhz comprises an antenna ARF1, means RRF1 to receive a signal carrying the identifier ID of a person, mean ERF1 to transmit a signal carrying risk information IR.

The means RRF1 and ERF1 preferably implement a RFID UHF type protocol which is type EPC Class 1 Gen 2, EPC Class 1 Gen 1 or ISO 18000-6c. The means RRF1 and ERF1 are linked to antenna ARF1.

The radiofrequency communication device RF2, preferably type Zigbee or WiFi, comprises means RRF2 to receive a signal carrying risk information transmitted by another beacon, means ERF2 for transmitting a signal carrying either risk information or the identifier ID of the person.

According to a variant, the beacon BAL comprises the user interface IHMBAL which comprises for example an alphanumeric keypad and where applicable a display screen.

The beacon BAL also comprises a measurement management device GM linked to the management unit UBAL.

The measurement management device GM comprises means DGM to receive binary information from a risk detector in relation to the risk information IR.

As a variant means DGM are provided to receive risk information IR directly.

The measurement management device GM also comprises means CDGM to indicate to a risk detector the type and/or level of risk it must detect by preferably bidirectional communication between them.

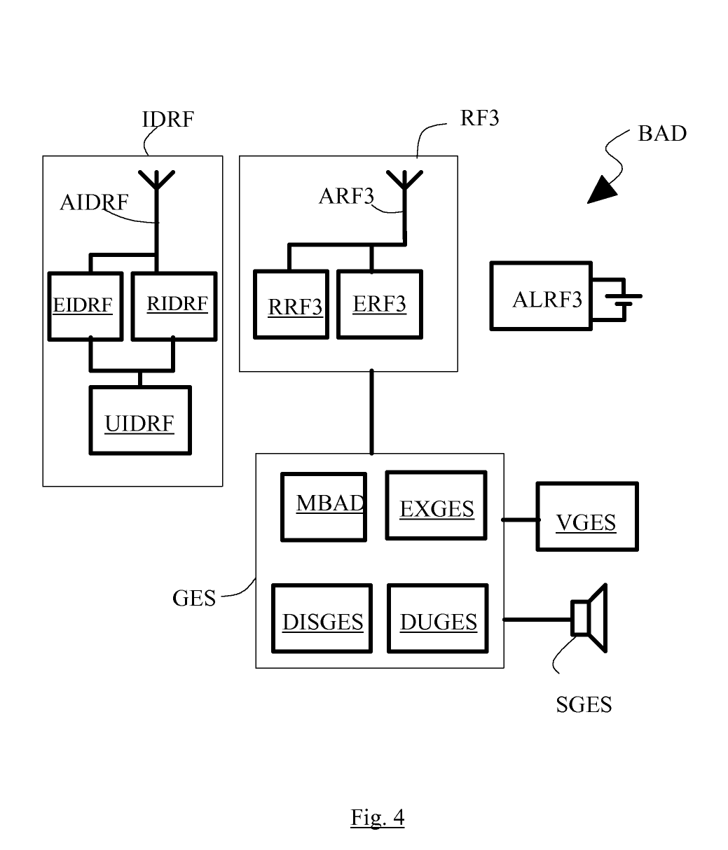

FIG. 4 shows diagrammatically the means internal to a badge BAD of the monitoring system SYST.

The badge BAD comprises a management device GES and a radiofrequency communication device RF3 which communicates with the management device GES.

The management device GES which comprises a memory MBAD, means DISGES to determine regularly its distance from the beacon, means DUGES to determine a duration for which the badge has remained under the cover of a beacon, means EXGS to determine from the risk information received a duration thus determined and at least one distance thus determined during this period, exposure information which describes the exposure duration of the person wearing the badge to a risk and the level of this risk.

The radiofrequency communication device RF3 is in communication with the management device GES. This device RF3 which preferably uses frequency 868 Mhz comprises an antenna ARF3, means RRF3 to receive a signal carrying risk information, means ERF3 for transmitting a signal carrying either an identifier ID of the person wearing it or exposure information which is stored in the memory MBAD, and means ALRF3 to supply the badge with energy.

Means RRF3 and ERF3 implement preferably an RFID UHF type protocol which is type EPC Class 1 Gen 2, EPC Class 1 Gen 1 or ISO 18000-6c. Means ALRF3, RRF3 and ERF3 are linked to antenna ARF3.

According to a variant of the management device GES, the device is associated with visual VGES and/or audible signalling means SGES for a risk detected. The visual means are for example an LCD display, an LED, a bistable display, and the audible means are for example a speaker, a vibrator or a piezo resonator.

According to a variant, the badge BAD also comprises a secure identification device IDRF provided to communicate either with a reader LIDRFID or a reader LRFID or both. The reader LRFID, type RFID long distance, preferably uses frequency 868 Mhz. The device IDRF comprises an antenna AIDRF, means EIDRF to transmit a signal carrying an identifier of a person stored in memory MBAD, means RIDRF to receive signal RFID UHF and a processing unit UIDRF.

FIG. 5 depicts another example of the monitoring system of a potentially high-risk area Z.

The system SYST2 comprises a plurality of beacons BALi, in this case five. Each beacon BAL is a beacon described in relation to FIG. 2. System SYST2 also comprises a plurality of risk detectors Ci, in this case two, each being associated with a beacon, in this case the risk detector C1 is associated with beacon BAL1 and risk detector C2 is associated with beacon BAL4.

Furthermore the system SYST2 comprises a badge BAD described in relation to FIG. 3 worn by a person and an apparatus GC responsible for centralised management of the monitoring system.

The potentially high-risk area Z is for example of very wide extent, or the range of each beacon BALi is very low. In any case in this example a single beacon cannot cover the potentially high-risk area Z, hence the use of several beacons. Beacons BALi are therefore positioned such that they cover the potentially high-risk area Z but also such that each beacon BALi is within range of at least one other beacon Bj which allows a signal carrying risk information IR to be broadcast throughout the area Z.

Beacons BALi are at rest i.e. are not transmitting any signal. When a risk is detected, for example by the risk detector C1, the risk detector C1 transmits a signal to beacon BAL1 carrying for example risk information IR. Beacon BAL1 then broadcasts this signal. Beacon BAL2, within range of beacon BAL1, then receives this signal. Reception of the signal activates beacon BAL2 which in turn broadcasts the signal received. Thus the beacon BAL2 in some way relays the signal so that the risk information IR detected in part of the high-risk area Z is broadcast throughout the zone.

According to a variant of the beacon described in relation to FIG. 3, each beacon BALi belongs to a group of beacons identified for example by a number and each beacon relays a signal carrying risk information IR only if the signal comes from a beacon BALj of its group. For example beacons BAL1, BAL2 belong to a first group GR1 and beacons BAL3, BAL4 and BAL5 belong to a second group GR2.

This variant is advantageous as a risk detected can only be harmful to a person if the person is close to risk detector C1 i.e. that which has detected the risk.

According to this grouping of beacons BALi it is advantageous for the apparatus GC to be linked to the beacon BAL3 which acts as a bridge between each beacon of each group with the apparatus GC. Thus each beacon is able to communicate with apparatus GC either directly or via another beacon of its group.

According to the example in FIG. 5, the risk information IR detected by the risk detector C1 can consequently only be broadcast over the part of the area Z delimited by the combination of cover of beacons BAL1 and BAL2.

When badge BAD comes within range of beacon BAL2 then activated, badge BAD receives the signal carrying the risk information. Steps 4 and 7 of the method in FIG. 2 are then implemented and where applicable steps 5 and 6.

The badge BAD then transmits the signal S2 carrying the exposure information it has just determined to the apparatus GC for the exposure information to be processed.

1-16. (canceled)

17. Method for monitoring a person likely to be in a potentially high-risk area, comprising the steps of:
activating a radiofrequency communication apparatus called a beacon,
broadcasting a signal carrying risk information occurring in said potentially high-risk area, which defines a type of risk and a level of severity,
receiving the signal carrying the risk information by a badge worn by the person,
transmitter via the badge of an identifier of the person to the beacon,
determining by the badge of information on exposure of the person to the risk, and
transmitting the exposure information to a remote apparatus responsible for centralised risk management.

18. The method according to claim 17, further comprising activating the beacon either directly by a user or by a signal from at least one remote trigger.

19. The method according to claim 18, wherein said activating step comprises activating the beacon via a remote trigger comprising another beacon which transmits a signal carrying the risk information or a risk detector which transmits a signal carrying either a binary indication that a risk has been detected or the risk information.

20. The method according to claim 17, further comprising determining the exposure information from a distance between the badge and the beacon and from the risk information.

21. The method according to claim 17, further comprising, after step of transmitting via the badge of an identifier of the person to the beacon, performing a step of transmission by the beacon of a signal carrying the identifier of the person to another remote device.

22. The method according to claim 17, further comprising, after transmission by the badge of an identifier of the person to the beacon, performing a step of audible and/or visual signaling by the badge.

23. The method according to claim 17, further comprising monitoring access of the person to the potentially high-risk area from RFID communication between the badge and an RFID reader.

24. A beacon to be used in a system for monitoring a person wearing a badge and likely to be in a potentially high-risk area, comprising:
means for implementing the steps of claim 17,
a first radiofrequency communication device intended to communicate with a badge, and
a second radiofrequency communication device intended to communicate with a remote apparatus and with another beacon, said first radiofrequency communicating device, comprising an antenna, means for receiving a signal carrying an identifier of said person, and means for transmitting a signal carrying risk information, and said second radiofrequency communicating device, comprising one of type Zigbee and WiFi, and further comprising means to receive a signal carrying risk information transmitted by another beacon, and means for transmitting a signal carrying one of risk information and an identifier of the person.

25. The beacon according to claim 24, further comprising a user interface.

26. The beacon according to claim 24, further comprising a measurement management device comprising means for receiving one of either a binary indication from a risk detector which is relative to risk information, and risk information.

27. The beacon according to claim 26, having a risk being detected by a risk detector, and wherein, the measurement management device also comprises means for indicating to said risk detector at least one of the type and level of the risk it which must be detected.

28. A badge worn by a person likely to be in a potentially high-risk area, comprising:
means for implementing the steps of claim 17,
a management device, and
a radiofrequency communication device which is
communication with the management device,
said management device comprising a memory, means for determining a distance of the badge from a beacon transmitting a risk information, information which defines a type of risk and level of severity, means for determining a duration during which the badge has remained under cover of said beacon, means for determining from said risk information thus received, the duration thus determined and a distance thus determined, exposure information which describes the duration of exposure of a person wearing the badge to said risk and the level of said risk, said radiofrequency communication device, comprising a memory, an antenna, means for receiving a signal carrying risk information, means for transmitting a signal carrying having one of an identifier of the person wearing the badge and exposure information which is stored in the memory, and means for supplying the badge with energy, and the communication protocol being used is one of type EPC Class 1 Gen2, EPC Class 1 GEN 1 and ISO 18000-6c.

29. The badge according to claim 28, wherein the management device is associated with visual and/or audible means for signalling a risk detected.

30. The badge according to claim 28, wherein the badge comprises a secure identification device of a person implementing a long distance RIFD type technology, using frequency 868 Mhz.

31. A system for monitoring persons each wearing a badge and likely to be in a potentially high-risk area, comprising at least one beacon in accordance with claim 24, a remote apparatus linked the at least one beacon which is responsible for centralised management of exposure of said persons to a risk, and in that the badge worn by each person comprises:
means for implementing the steps of claim 17,
a management device, and
a radiofrequency communication device which is
communication with the management device,
said management device comprising a memory, means for determining a distance of the badge from a beacon transmitting a risk information, information which defines a type of risk and level of severity, means for determining a duration during which the badge has remained under cover of said beacon, means for determining from said risk information thus received, the duration thus determined and a distance thus determined, exposure information which describes the duration of exposure of a person wearing the badge to said risk and the level of said risk, said radiofrequency communication device, comprising a memory, an antenna, means for receiving a signal carrying risk information, means for transmitting a signal carrying having one of an identifier of the person wearing the badge and exposure information which is stored in the memory, and means for supplying the badge with energy, and the communication protocol being used is one of type EPC Class 1 Gen2, EPC Class 1 GEN 1 and ISO 18000-6c.

32. The system according to claim 31, further comprising several beacons grouped into separate groups, and a broadcast of a signal carrying risk information transmitted by a beacon of one group being limited to a combination of cover of the beacons belonging to second one group.
